(19) United States
(12) Patent Application Publication
(10) Pub. No.: US 2022/0277731 A1
(43) Pub. Date: Sep. 1, 2022

(54) WORD WEIGHT CALCULATION SYSTEM

(71) Applicant: NTT DOCOMO, INC., Chiyoda-ku (JP)

(72) Inventors: Taku KATOU, Chiyoda-ku (JP); Yusuke NAKASHIMA, Chiyoda-ku (JP); Taichi ASAMI, Chiyoda-ku (JP)

(73) Assignee: NTT DOCOMO, INC., Chiyoda-ku (JP)

(21) Appl. No.: 17/628,377

(22) PCT Filed: Jun. 10, 2020
(86) PCT No.: PCT/JP2020/022900

§ 371 Date: Jan. 19, 2022

(30) Foreign Application Priority Data
Aug. 6, 2019 (JP) 2019-144430

(51) Int. Cl. G10L 15/06; G06F 40/242

(52) U.S. Cl. CPC G10L 15/063; G06F 40/242; G10L 2015/0635

(57) ABSTRACT

A word weight calculation system is a system that calculates the weight of an additional word registered in a word dictionary used for speech recognition, and includes: a text acquisition unit configured to acquire a combination of a speech recognition result text, which is a result of speech recognition using a word dictionary including an additional word with a predetermined weight set in advance, and a correct text, which is a correct answer for the speech recognition, the combination including the additional word in any of the texts; and a weight calculation unit configured to calculate the weight of the additional word according to an erroneous word corresponding to the additional word included in any of the acquired texts, and a preset number of preceding words before the additional word or the erroneous word included in the correct text.

### TECHNICAL FIELD

The present invention relates to a word weight calculation system for calculating the weight of an additional word registered in a word dictionary used for speech recognition.

### BACKGROUND ART

A speech recognition model used for speech recognition includes a word dictionary used for recognizing individual words. The word dictionary usually includes notation, phonetic spelling, and weight information for each word. The weight of a word usually indicates the appearance probability of the word during speech recognition. In order to make a new additional word speech-recognized, it is necessary to register the information of the additional word in the word dictionary. For accurate speech recognition of an additional word, an appropriate weight should be given to the additional word.

Patent Literature 1 discloses a method for determining the weight of an additional word. In this method, first, from the speech-recognized text including an additional word, the percentage of insertion errors and the percentage of correct answers for the additional word are calculated. The calculated percentage of insertion errors and the calculated percentage of correct answers are compared with threshold values stepwise, and a new weight is selected from a maximum of four weights set in advance.

### CITATION LIST

### Patent Literature

Patent Literature 1: Japanese Unexamined Patent Publication No. 2009-271465

### Summary of Invention

### Technical Problem

In the method shown in Patent Literature 1, the weight of the additional word is determined based on the percentage of insertion errors and the percentage of correct answers, but there is a possibility that the weight is determined without taking the context into consideration. For this reason, when speech recognition is performed by using the weight determined by the method shown in Patent Literature 1, there is a possibility that an additional word may not be recognized in the context in which the additional word is likely to appear or the additional word may be inserted in the context in which the additional word does not appear.

An embodiment of the present invention has been made in view of the above, and it is an object of the embodiment of the present invention to provide a word weight calculation system capable of setting an appropriate weight when registering an additional word in a word dictionary used for speech recognition.

### Solution to Problem

In order to achieve the aforementioned object, a word weight calculation system according to an embodiment of the present invention is a word weight calculation system that calculates a weight of an additional word registered in a word dictionary used for speech recognition, and includes: a text acquisition unit configured to acquire a combination of a speech recognition result text, which is a result of speech recognition using a word dictionary including an additional word with a predetermined weight set in advance, and a correct text, which is a correct answer for the speech recognition, the combination including the additional word in any of the texts; and a weight calculation unit configured to calculate the weight of the additional word according to an erroneous word corresponding to the additional word included in any of the texts acquired by the text acquisition unit, and a preset number of preceding words before the additional word or the erroneous word included in the correct text.

In the word weight calculation system according to the embodiment of the present invention, the weight of the additional word is calculated in consideration of the preceding word as well as the recognition error of the additional word in speech recognition.

Therefore, according to the word weight calculation system according to the embodiment of the present invention, since the weight of the additional word can be calculated in consideration of the context, it is possible to set the appropriate weight when registering the additional word in the word dictionary used for speech recognition.

Advantageous Effects of Invention

According to the embodiment of the present invention, since the weight of the additional word can be calculated in consideration of the context, it is possible to set the appropriate weight when registering the additional word in the word dictionary used for speech recognition.

### BRIEF DESCRIPTION OF DRAWINGS

FIG. 1 is a diagram showing the configuration of a word weight calculation system according to an embodiment of the present invention.

FIG. 2 is a diagram showing an example of a 3-gram extracted from each of a correct text and a speech recognition result text.

FIG. 3 is a table in which a recall rate, a precision rate, and an error example list for additional words are stored in association with each other.

FIG. 4 is a flowchart showing a process executed by the word weight calculation system according to the embodiment of the present invention.

FIG. 5 is a diagram showing a hardware configuration of the word weight calculation system according to the embodiment of the present invention.

### DESCRIPTION OF EMBODIMENTS

Hereinafter, an embodiment of a word weight calculation system according to the present invention will be described in detail together with the diagrams. In addition, in the description of the diagrams, the same elements are denoted by the same reference numerals, and repeated description thereof will be omitted.

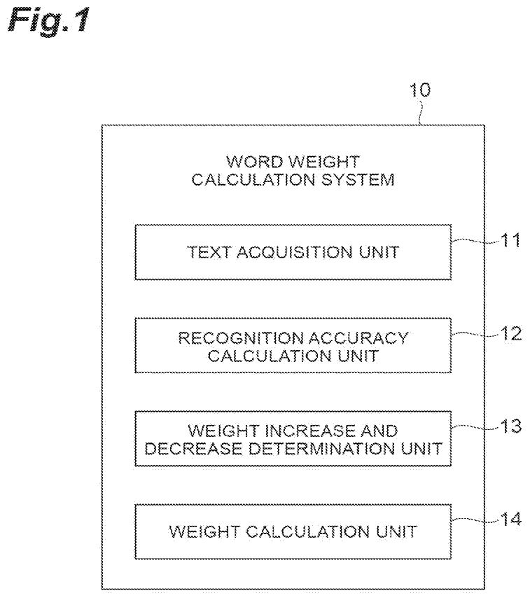

FIG. 1 shows a word weight calculation system 10 according to the present embodiment. The word weight calculation system 10 is a system (device) for calculating the weight of an additional word registered in a word dictionary used for speech recognition. In the present embodiment, Japanese speech recognition will be described as an example. However, even in the case of speech recognition other than

Japanese, a word weight calculation system can be implemented in the same manner as in the present embodiment as long as the speech recognition is performed in the same framework as in the present embodiment. In speech recognition, a speech recognition model including a word dictionary is used. Speech recognition is performed by recognizing the words included in the word dictionary. Therefore, words that are not included in the word dictionary cannot be speech-recognized. In order to speech-recognize a new word, it is necessary to add the new word to be recognized to the word dictionary.

The word dictionary stores information necessary for speech recognition for each word. The word dictionary stores the notation, phonetic spelling, and the like of each word as its information. Word notation is a description output as a speech recognition result. Phonetic spelling is information that is compared with speech. Word notation and phonetic spelling are set in advance for each word.

In addition, a weight is set for each word included in the word dictionary. The weight of a word usually indicates the appearance probability of the word during speech recognition. The larger (stronger) the weight, the easier it is for the word to be speech-recognized (more likely to appear in the text as a result of speech recognition), and the smaller (weaker) the weight, the harder it is for the word to be speech-recognized (less likely to appear in the text as a result of speech recognition).

For example, when the weight of a word “ARPU (pronounced “aapu”)” is small, a recognition result text for the speech (correct text) of “. . . de onsei ARPU (speech ARPU by) . . . ” may be “. . . de onsei up (speech up by) . . . ”. Therefore, an error that the word “ARPU” does not appear may occur. In addition, when the weight of a word “matter” is large, a recognition result text for the speech (correct text) of “. . . ga dekite mata (can be done and) . . . ” may be “. . . ga dekite matter (can be done matter) . . . ”. Therefore, an error (insertion) that the word “matter” appears erroneously may occur.

Speech recognition is performed by a speech recognition engine based on a speech recognition model set in advance. The speech recognition model is a framework for performing speech recognition, and includes, for example, an acoustic model, a language model, a word dictionary, and the like. The speech recognition model in the present embodiment can target a known speech recognition model (speech recognition technology). The acoustic model includes a “neural network+hidden Markov model”, a “Gaussian mixture model+hidden Markov model”, or the like. In addition, other acoustic models may be targeted.

As a language model, a class language model is common. In the present embodiment, the class language model is targeted. In the class language model, a word belongs to one of a plurality of classes set in advance. A class indicates a classification of a word, for example, a classification of a person's name, a place name or the like. The word dictionary stores information indicating a class for each word. The class is set in advance for each word.

The weight of a word in the word dictionary in the present embodiment is premised on a class. For example, the weight of a word is an intra-class probability. The intra-class probability is a probability that the word appears in the class to which the word belongs.

In addition, as a language model, a language model that considers words before and after each word to be speech-recognized in the speech-recognized speech (text) at the time of speech recognition, that is, an n-gram language model is used. In the present embodiment, the n-gram language model is targeted. For example, in a 3-gram language model that also considers two words before a word to be speech-recognized, a probability P(w₃|w₁, w₂) that a word w₁, a word w₂, and a word w₃ are continuously speech-recognized is shown as follows.

P(w₃|w₁, w₂)=P(Cᵢ|w₁, w₂)P(w₃|Cᵢ)

Here, C1 is a class to which the word w₃ belongs, P(Cᵢ|w₁, w₂) is a probability that a word of the class C1 appears after the word wi and the word w₂, and P(w₃|Cᵢ) is the weight of the word w₃ (intra-class probability of the word w₃). The above probability P(w₃|w₁, w₂) is used for the recognition of a word in speech recognition.

As described above, P(w₃|Cᵢ) is included in the word dictionary. P(Cᵢ|w₁, w₂) is calculated based on the language model at the time of speech recognition. By changing the weight of a word, the ease of appearance of the word in each context changes.

The word weight calculation system 10 calculates the weight of an additional word when a new additional word is registered in the word dictionary. The word weight calculation system 10 calculates P(w_{new}|Cᵢ) as the weight of an additional word w_{new}. The word weight calculation system 10 may perform speech recognition by using a word dictionary. That is, the word weight calculation system 10 may be a part (function) of a system that performs speech recognition. In addition, the word weight calculation system 10 may be configured independently of the system that performs speech recognition. In this case, the word weight calculation system 10 provides information indicating the calculated weight of the additional word to the system that performs speech recognition.

The word weight calculation system 10 is implemented by, for example, a server device. In addition, the word weight calculation system 10 may be implemented by a plurality of server devices, that is, a computer system.

Subsequently, the function of the word weight calculation system 10 according to the present embodiment will be described. As shown in

FIG. 1, the word weight calculation system 10 includes a text acquisition unit 11, a recognition accuracy calculation unit 12, a weight increase and decrease determination unit 13, and a weight calculation unit 14. In the word weight calculation system 10, an additional word is set and stored in advance when processing for calculating the weight of the additional word is performed. The setting of the additional word is performed by, for example, the administrator of the word weight calculation system 10. The number of additional words may be plural.

The text acquisition unit 11 is a functional unit that acquires a combination of the speech recognition result text, which is a result of speech recognition using a word dictionary including an additional word with a predetermined weight set in advance, and the correct text, which is a correct answer for the speech recognition, the combination including the additional word in any of the texts.

When calculating the weight of the additional word in the word weight calculation system 10, speech recognition is performed by using a word dictionary in which the additional word is temporarily registered. The predetermined weight of the additional word at this time is a default value that is an initial value set in advance. The default value is a uniform value, for example, 1.0. In addition, even if the weight of a word registered in the word dictionary is larger than 1.0, the probability

P that three words are continuously speech-recognized can be calculated based on the above equation. Therefore, the weight of the additional word calculated by the weight calculation unit 14 may be a value larger than 1.0.

Speech recognition is performed by using the speech recognition engine described above. Speech recognition may be performed by the word weight calculation system 10 (text acquisition unit 11), or may be performed by a system other than the word weight calculation system 10. Speech recognition is usually performed on speech relevant to a plurality of texts (sentences).

The text acquisition unit 11 acquires a speech recognition result text which is a result of speech recognition using the above word dictionary. When speech recognition is performed by the word weight calculation system 10, the text acquisition unit 11 stores the speech recognition engine and the word dictionary described above in advance.

In the word dictionary, the additional word is temporarily registered as described above. The text acquisition unit 11 acquires a speech (speech data) to be speech-recognized, and performs speech recognition based on the stored speech recognition engine and the word dictionary for the acquired speech to acquire a speech recognition result text. The speech acquisition is performed, for example, by an operation of inputting speech to the word weight calculation system 10 by the administrator of the word weight calculation system 10 or the like.

When speech recognition is performed by an external system, the text acquisition unit 11 acquires the speech recognition result text from the external system. The speech recognition performed by the external system is the same as the speech recognition performed by the text acquisition unit 11 described above.

The text acquisition unit 11 acquires a correct text, which is a correct answer for the speech recognition relevant to the speech recognition result text. The correct text is, for example, a transcription text that is a transcribed text of speech. However, the speech may be a reading of the correct text prepared in advance. For example, the correct text is prepared in advance by the administrator of the word weight calculation system 10 or the like, and is input to the word weight calculation system 10 in association with the speech relevant to the correct text or the speech recognition result text. The text acquisition unit 11 receives and acquires the correct text.

In this manner, the text acquisition unit 11 acquires the combination of the speech recognition result text and the correct text. The text acquisition unit 11 acquires a plurality of combinations (that is, combinations of a plurality of speeches). The combinations acquired by the text acquisition unit 11 include a combination including an additional word in any of the texts. The additional word may be included in both texts of the combination, or may be included in only one of the texts.

In addition, the combinations acquired by the text acquisition unit 11 may include a combination not including an additional word in any of the texts. However, the combination is not used in the calculation of the weight of the additional word. In addition, the plurality of combinations acquired by the text acquisition unit 11 may be used to calculate the weights of a plurality of additional words. The speech relevant to the text acquired by the text acquisition unit 11 may be a speech prepared for calculating the weight of the additional word, that is, a development set speech.

The text acquired by the text acquisition unit 11 is a text divided into words, for example, a word-divided text. If the text is not divided into words at the time of acquisition by the text acquisition unit 11, the text acquisition unit 11 divides the acquired text into words by using a conventional technique, such as morphological analysis. The text acquisition unit 11 outputs the acquired text combination to the recognition accuracy calculation unit 12.

The recognition accuracy calculation unit 12 is a functional unit that calculates the recognition accuracy of the additional word from the combination of the speech recognition result text and the correct text acquired by the text acquisition unit 11. The recognition accuracy calculation unit 12 may calculate at least one of the precision rate and the recall rate as the recognition accuracy of the additional word.

The recognition accuracy calculation unit 12 receives a combination of the speech recognition result text and the correct text from the text acquisition unit 11. The recognition accuracy calculation unit 12 performs association (alignment) of each word for the received text combination. The alignment is to detect which word in the correct text combined with the speech recognition result text corresponds to each word in the speech recognition result text (or vice versa). The alignment may be performed by using a conventional publicly available algorithm or tool, such as dynamic programming

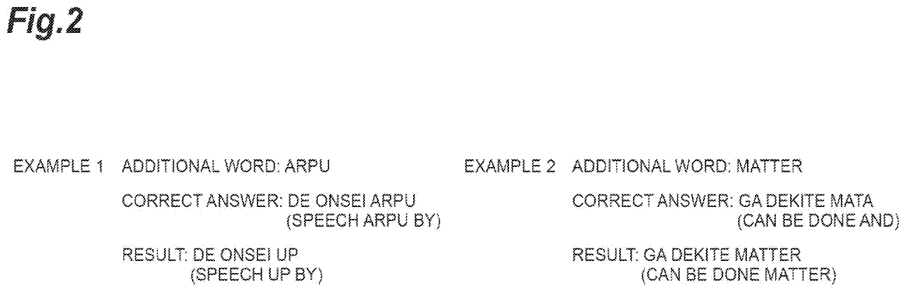

From the alignment result, the recognition accuracy calculation unit 12 extracts an n-gram, which is a string of n consecutive words including the additional word at the nth position, from the text. n is a numerical value of 2 or more. In the present embodiment, basically, n=3, that is, a 3-gram is extracted. That is, the recognition accuracy calculation unit 12 extracts a 3-gram, which is a string of three consecutive words including the additional word at the third position, from either the speech recognition result text or the correct text. In addition, the recognition accuracy calculation unit 12 extracts a 3-grain, which is a string of three consecutive words including a word corresponding to the additional word at the third position, from the other text of the combination. Example 1 of FIG. 2 shows a 3-grain extracted from each of the correct text and the speech recognition result text when the additional word is included in the correct text. Example 2 of FIG. 2 shows a 3-gram extracted from each of the correct text and the speech recognition result text when the additional word is included in the speech recognition result text.

When the additional word appears second from the beginning of the text, the recognition accuracy calculation unit 12 extracts a 3-grain including a beginning symbol <s>. When the additional word appears at the beginning of the text, the recognition accuracy calculation unit 12 extracts a 2-gram including the beginning symbol <s>.

The recognition accuracy calculation unit 12 calculates the recognition accuracy for the additional word based on the extracted 3-gram and 2-gram alignments. The recognition accuracy calculation unit 12 calculates a recall rate R as one of the recognition accuracy by using the following equation. Recall rate R=Number by which the ends of 3-gram and 2-gram extracted from the correct text are additional words and the words of the alignment of the additional word (last words of 3-gram and 2-gram extracted from the speech recognition result text) are also additional words (that is, the number by which the additional words in the correct text can be correctly speech-recognized)/Number by which the ends of 3-gram and 2-grain extracted from the correct text are additional words

In addition, the recognition accuracy calculation unit 12 calculates a precision rate P as one of the recognition accuracy by using the following equation.

Precision rate P=Number by which the ends of 3-gram and 2-gram extracted from the correct text are additional words and the words of the alignment of the additional word (last words of 3-gram and 2-gram extracted from the speech recognition result text) are also additional words (that is, the number by which the additional words in the correct text can be correctly speech-recognized)/Number by which the ends of 3-gram and 2-grain extracted from the speech recognition result text are additional words

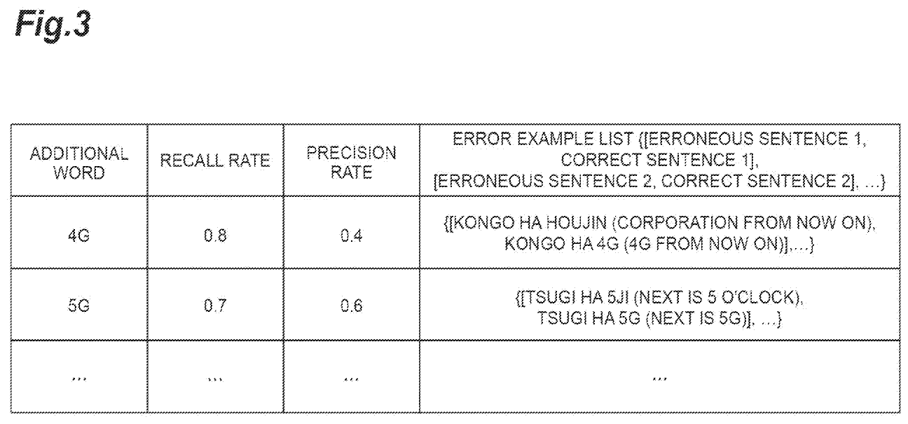

The recognition accuracy calculation unit 12 sets erroneously recognizing an additional word in the extracted 3-gram and 2-grain alignments as an “error example”. That is, the “error example” is an alignment in which an additional word is extracted from only one of the correct text and the speech recognition result text, and is an alignment in which an additional word is included only at the end of either one. Therefore, the “error example” includes two patterns: erroneously recognizing an additional word in the correct text as a word other than the additional word (additional word is spoken but not recognized as the additional word) and erroneously recognizing a word other than an additional word in the correct text as the additional word (word other than the additional word is spoken but the additional word is inserted (speech-recognized as the additional word)). The recognition accuracy calculation unit 12 stores the recall rate R, the precision rate P, and the error example list in association with each other for the additional words. When there are a plurality of additional words, the recognition accuracy calculation unit 12 stores each piece of information in the table shown in FIG. 3. In the error example list shown in FIG. 3, an erroneous sentence is a 3-grain or a 2-grain of the error example extracted from the speech recognition result text, and the correct sentence is a 3-grain or a 2-gram of the error example extracted from the correct text.

The weight increase and decrease determination unit 13 is a weight function unit that determines an increase or decrease of the weight of an additional word from the default value (predetermined weight) based on the recognition accuracy calculated by the recognition accuracy calculation unit 12.

The weight increase and decrease determination unit 13 performs determination with reference to the information in the table shown in FIG. 3 stored by the recognition accuracy calculation unit 12. The weight increase and decrease determination unit 13 performs determination for each additional word for which the weight is calculated. The weight increase and decrease determination unit 13 reads the recall rate R and the precision rate P from the table shown in FIG. 3, and performs determination based on the following determination criteria stored in advance. The determination criteria include a threshold value T set in advance.

The weight increase and decrease determination unit 13 compares each of the recall rate R and the precision rate P with the threshold value T, and determines whether or not to increase, decrease, or maintain from the default value based on the comparison result. For example, the weight increase and decrease determination unit 13 performs the determination as follows. When R≥T and P≥T, the weight is maintained. This is because the current weight is appropriate when both the recall rate R and the precision rate P are high. When R<T and P≥T, the weight is increased. This is because when only the recall rate R is high, a higher weight than the current one is appropriate so that the additional word is likely to appear. When R≥T and P<T, the weight is decreased. This is because when only the precision rate P is high, a lower weight than the current one is appropriate so that the additional word is less likely to appear. When R<T and P<T, the weight is decreased. When both the recall rate R and the precision rate P are low, a lower weight than the current one is set so that the additional word is less likely to appear in order to cope with insertion.

In addition, it is determined that the weight is maintained for the additional word that does not appear in the speech recognition result text and the correct text. In this case, however, the weight may be calculated again by using another speech recognition result text and another correct text in which the additional word appears. In addition, for the additional word that appears only in the correct text, it may be determined that the weight is increased so that the additional word is likely to appear. For the additional word that appears only in the speech recognition result text, it may be determined that the weight is decreased so that the additional word is less likely to appear. However, in these cases as well, the weight may be calculated again by using another speech recognition result text and another correct text. In addition, depending on the number of additional words appearing in the speech recognition result text and the correct text (for example, when these numbers are less than a predetermined number), the weight may be calculated again by using another speech recognition result text and another correct text. The weight increase and decrease determination unit 13 notifies the weight calculation unit 14 of the determination result for each additional word.

The weight calculation unit 14 is a functional unit that calculates the weight of the additional word according to an erroneous word corresponding to the additional word included in any of the texts acquired by the text acquisition unit 11 and a preset number of preceding words before the additional word or the erroneous word included in the correct text. Here, any of the texts is a speech recognition result text or a correct text. In addition, the erroneous word is a word that appears in the speech recognition result text due to erroneous recognition of the additional word in the correct sentence text or a word in the correct sentence text erroneously recognized as the additional word.

The weight calculation unit 14 may calculate a probability that an erroneous word appears after the preceding word based on the speech recognition model used for speech recognition and calculate the weight of the additional word according to the calculated probability. The weight calculation unit 14 may calculate a probability that a word of the class to which the additional word belongs appears after the extracted preceding word based on the speech recognition model used for speech recognition and calculate the weight of the additional word also according to the calculated probability. The weight calculation unit 14 may calculate the weight of the additional word also according to the determination by the weight increase and decrease determination unit 13.

The weight calculation unit 14 calculates the weight of the additional word as follows. When there are a plurality of additional words, the weight calculation unit 14 calculates the weight for each additional word.

The weight calculation unit 14 receives a notification of the determination result from the weight increase and decrease determination unit 13. For the additional word determined to maintain the weight, the weight calculation unit 14 sets the default value, which is a current value, as the weight of the additional word.

For the additional word determined to increase the weight, the weight calculation unit 14 reads the error example list of the additional word, which is stored in the table shown in FIG. 3 by the recognition accuracy calculation unit 12, and uses the read error example list for the calculation of the weight. Here, in the error example list, an error example in which the additional word in the correct text is erroneously recognized as a word other than the additional word (an error example in which the additional word is spoken but not recognized as the additional word) is used. The weight calculation unit 14 calculates the weight P(w_{new}|Cᵢ) of an additional word w_{new} by using the following equation (i).

$$[ Equation 1 ]$$

$$P ( {w}_{new} \vert {C}_{i} ) = max \frac{P ( {w}^{′} \vert 〈 h 〉 )}{P ( {C}_{i} \vert 〈 h 〉 )} + b \qquad ( i )$$

Here, <h> is a preset number of preceding words before the additional word in the correct text. Specifically, <h> is two words or one word before the additional word, and is a word before the additional word of a 3-gram or a 2-gram that is a correct sentence in the error example list. w′ is an erroneous word corresponding to the additional word, and is a last word of a 3-gram or a 2-gram that is an erroneous sentence in the error example list. P(w|<h>) is a 3-gram probability or a 2-gram probability that is a probability that a word w appears after a preceding word <h>. b is a positive constant set in advance.

In speech recognition, in order to make the additional word in the correct sentence more likely to appear than in the erroneous sentence, it is necessary to satisfy P(w_{new}|<h>)>P(w′|<h>). By transforming this equation, the following equation is obtained.

$$P ( {w}_{new} \vert {C}_{i} ) > \frac{P ( {w}^{′} \vert 〈 h 〉 )}{P ( {C}_{i} \vert 〈 h 〉 )} \qquad [ Equation 2 ]$$

In order to make the additional word more likely to appear in all the above error examples for the additional word, equation (i) is obtained.

The weight calculation unit 14 calculates P(Cᵢ|<h>) in equation (i) based on the speech recognition model in the same manner as in the case of speech recognition. The weight calculation unit 14 calculates

P(Cⱼ|<h>) based on the speech recognition model in the same manner as in the case of speech recognition. Here, Cⱼ is a class of the erroneous word w′. The weight calculation unit 14 calculates P(w′|<h>)=P(Cⱼ|<h>)P(w′|Cⱼ), which is the numerator of the first term in equation (i), from the calculated P(Cⱼ|<h>) and P(w′|Cⱼ) stored in advance. The weight calculation unit 14 calculates P(w_{new}|Cᵢ) from the calculated P(Cᵢ|<h>) and P(w′|<h>) by using equation (i).

The weight calculation unit 14 compares the calculated P(w_{new}|Cᵢ) with a default weight Pold(W_{new}|Cᵢ). When P(w_{new}|Cᵢ) is larger than P_{old}(w_{new}|Cᵢ), the weight calculation unit 14 sets the calculated P(w_{new}|Cᵢ) as the weight of the additional word w_{new}. When P(w_{new}|Cᵢ) is not larger than P_{old}(w_{new}|Cᵢ), the weight calculation unit 14 calculates the weight P(w_{new}|Cᵢ) of the additional word w_{new} by using the following equation (ii) and sets the calculated weight P(w_{new}|Cᵢ) as the weight of the additional word wnew.

### [Equation 3]

P(w_{new}|Cᵢ)=P_{old}(w_{new}|Cᵢ)+d (ii)

Here, d is a positive constant set in advance. The weight P(w_{new}|Cᵢ) calculated by equation (ii) is larger than the default value of the weight. The above is the calculation of the weight for the additional word determined to increase the weight.

For the additional word determined to decrease the weight, the weight calculation unit 14 reads the error example list of the additional word, which is stored in the table shown in FIG. 3 by the recognition accuracy calculation unit 12, and uses the read error example list for the calculation of the weight. Here, in the error example list, an error example in which a word other than the additional word in the correct text is erroneously recognized as the additional word (an error example in which a word other than the additional word is spoken but the additional word is inserted) is used. The weight calculation unit 14 calculates the weight P(w_{new}|Cᵢ) of an additional word w_{new} by using the following equation (iii).

$$[ Equation 4 ]$$

$$P ( {w}_{new} \vert {C}_{i} ) = min \frac{P ( {w}^{′} \vert 〈 h 〉 )}{P ( {C}_{i} \vert 〈 h 〉 )} - b \qquad ( iii )$$

Here, <h> is a preset number of preceding words before the erroneous word erroneously recognized as an additional word in the correct text. Specifically, <h> is two words or one word before the erroneous word, and is a word before the erroneous word of a 3-gram or a 2-gram that is a correct sentence in the error example list. w′ is an erroneous word corresponding to the additional word, and is a last word of a 3-gram or a 2-gram that is a correct sentence in the error example list. P(w|<h>) is a 3-gram probability or a 2-gram probability that is a probability that the word w appears after the preceding word <h>. b is a positive constant set in advance. In addition, b herein may be a value different from b in equation (i).

In speech recognition, in order to make the erroneous word w′ in the correct sentence more likely to appear than the additional word in the erroneous sentence (make the additional word in the erroneous sentence less likely to appear), it is necessary to satisfy P(w_{new}|<h>)<P(w′|<h>). By transforming this equation, the following equation is obtained.

$$P ( {w}_{new} \vert {C}_{i} ) < \frac{P ( {w}^{′} \vert 〈 h 〉 )}{P ( {C}_{i} \vert 〈 h 〉 )} \qquad [ Equation 5 ]$$

In order to make the additional word less likely to appear in all the above error examples for the additional word, equation (iii) is obtained.

The weight calculation unit 14 calculates P(Cᵢ|<h>) in equation (iii) based on the speech recognition model in the same manner as in the case of speech recognition. The weight calculation unit 14 calculates P(Cⱼ|<h>) based on the speech recognition model in the same manner as in the case of speech recognition. Here, C₁ is a class of the error word w′. The weight calculation unit 14 calculates P(w′|<h>)=P(Cᵢ|<h>)P(w′|Cⱼ), which is the numerator of the first term in equation (iii), from the calculated P(Cᵢ|<h>) and P(w′|Cᵢ) stored in advance. The weight calculation unit 14 calculates P(w_{new}|Cᵢ) from the calculated P(Cᵢ|<h>) and P(w′|<h>) by using equation (iii).

The weight calculation unit 14 compares the calculated P(w_{new}|Cᵢ) with the default weight P_{old}(w_{new}|Cᵢ). When P(w_{new}|Cᵢ is smaller than P_{old}(w_{new}|Cᵢ), the weight calculation unit 14 sets the calculated P(w_{new}|Cᵢ) as the weight of the additional word w_{new}. When P(w_{new}lCᵢ) is not smaller than P_{old}(w_{new}|Cᵢ), the weight calculation unit 14 calculates the weight P(w_{new}|Cᵢ) of the additional word w_{new} by using the following equation (iv) and sets the calculated weight P(w_{new}|Cᵢ) as the weight of the additional word w_{new}.

### [Equation 6]

P(w_{new}|Cᵢ)=P_{old}(w_{new}|Cᵢ)−d (iv)

Here, d is a positive constant set in advance. In addition, d herein may be a value different from d in equation (ii). The weight P(w_{new}|Cᵢ) calculated by equation (iv) is smaller than the default value of the weight. The above is the calculation of the weight for the additional word determined to decrease the weight.

The weight calculation unit 14 outputs information indicating the weight of the additional word calculated as described above. For example, when the word weight calculation system 10 is a part of a system that performs speech recognition, the weight calculation unit 14 registers the weight of the additional word in its own word dictionary and outputs the weight of the additional word. When the word weight calculation system 10 is configured independently of the system that performs speech recognition, the weight calculation unit 14 outputs information indicating the weight of the additional word to the system that performs speech recognition. In addition, when outputting the weight of the additional word, the weight calculation unit 14 may output information regarding the additional word registered in the word dictionary (for example, notation and phonetic spelling of the additional word) together with the weight of the additional word. The above is the function of the word weight calculation system 10 according to the present embodiment.

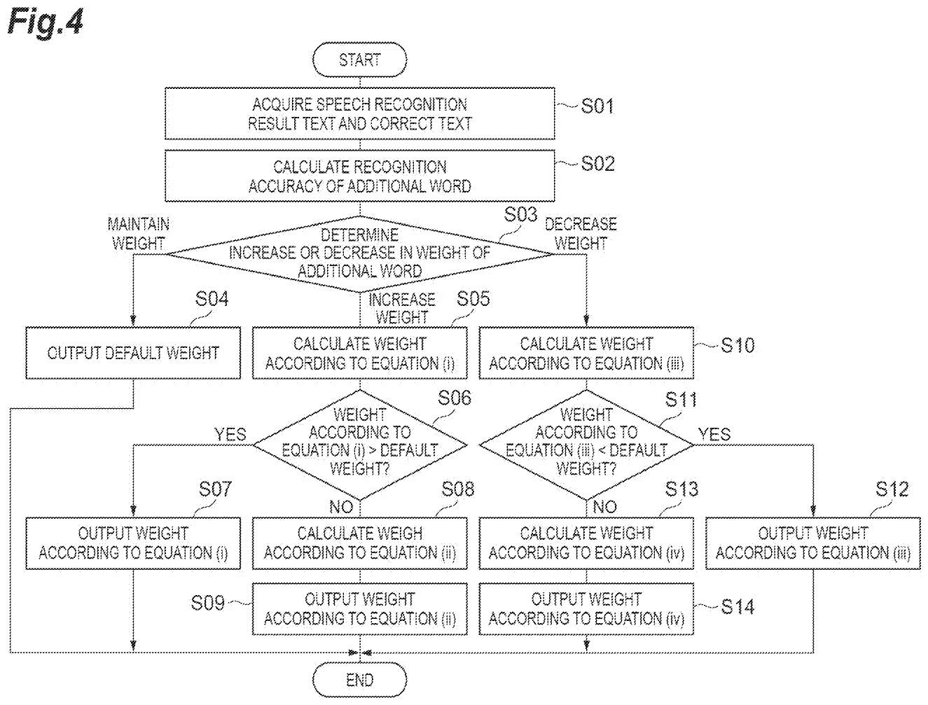

Subsequently, a process executed by the word weight calculation system 10 according to the present embodiment (a method of an operation performed by the word weight calculation system 10) will be described with reference to the flowchart of FIG. 4.

In this process, first, the text acquisition unit 11 acquires a combination of a speech recognition result text and a correct text (S01). Then, the recognition accuracy calculation unit 12 calculates the recognition accuracy of an additional word from the combination of the speech recognition result text and the correct text (S02). The recognition accuracy is, for example, a precision rate and a recall rate. Then, the weight increase and decrease determination unit 13 determines whether to increase or decrease the weight of the additional word from the default value based on the recognition accuracy (S03).

If it is determined that the weight is to be maintained (maintain weight in S03), the weight calculation unit 14 sets and outputs the default value, which is a current value, as the weight of the additional word, and the process ends (S04).

If it is determined that the weight is to be increased in S03 (increase weight in S03), the weight calculation unit 14 calculates the weight of the additional word according to the erroneous word included in the speech recognition result text and the preceding word before the additional word included in the correct text by using equation (i) (505). Then, the weight calculation unit 14 compares the calculated weight with the default weight (S06). If the weight according to equation (i) is larger than the default weight (YES in S06), the weight calculation unit 14 sets and outputs the weight according to equation (i) as the weight of the additional word, and the process ends (S07). If the weight according to equation (i) is not larger than the default weight in S06 (NO in S06), the weight calculation unit 14 calculates the weight of the additional word by using equation (ii) (S08). Then, the weight calculation unit 14 sets and outputs the weight according to equation (ii) as the weight of the additional word, and the process ends (S09).

If it is determined that the weight is to be decreased in S03 (decrease weight in S03), the weight calculation unit 14 calculates the weight of the additional word according to the erroneous word included in the correct text and the preceding word before the erroneous word by using equation (iii) (S10). Then, the weight calculation unit 14 compares the calculated weight with the default weight (S11). If the weight according to equation (iii) is smaller than the default weight (YES in S11), the weight calculation unit 14 sets and outputs the weight according to equation (iii) as the weight of the additional word, and the process ends (S12). If the weight according to equation (iii) is not smaller than the default weight in S11 (NO in S11), the weight calculation unit 14 calculates the weight of the additional word by using equation (iv) (S13). Then, the weight calculation unit 14 sets and outputs the weight according to equation (iv) as the weight of the additional word, and the process ends (S14). The above is the process executed by the word weight calculation system 10 according to the present embodiment.

In the present embodiment, the weight of the additional word is calculated in consideration of the preceding word as well as the recognition error of the additional word in speech recognition. Therefore, according to the present embodiment, since the weight of the additional word can be calculated in consideration of the context, it is possible to set the appropriate weight when registering the additional word in the word dictionary used for speech recognition. By setting the appropriate weight for the additional word, the additional word can be speech-recognized more accurately.

In addition, as in the present embodiment, a probability that an erroneous word appears after the preceding word may be calculated based on the speech recognition model used for speech recognition, and the weight of the additional word may be calculated according to the calculated probability. According to this configuration, the weight of the additional word can be calculated appropriately and reliably. In addition, based on the calculated probability, an appropriate weight of the additional word can be calculated by calculating the weight of the additional word by using the above-described equations (i) and (iii) and the like. In the method shown in Patent Literature 1 described above, since the weight can be set to only a plurality of stages set in advance (up to four stages), there is a possibility that an appropriate weight cannot be given for each additional word. By calculating the weight of the additional word based on the above-described probability as in the present embodiment, the weight of the additional word can be set to an appropriate weight without becoming a value of a plurality of stages.

However, in the calculation of the weight of the additional word, it is not always necessary to calculate the probability that the erroneous word appears after the preceding word, and the weight of the additional word may be calculated according to the erroneous word and the preceding word.

In addition, as in the present embodiment, the weight of the additional word may be calculated in consideration of the class of the word. According to this configuration, the weight of the additional word in a commonly used class language model can be calculated appropriately. However, the weight of an additional word that does not assume a class may be calculated.

In addition, the recognition accuracy of an additional word may be calculated in speech recognition in which an additional word with a weight set as a default value is used as in the present embodiment, and an increase or decrease from the default value may be determined. The calculated recognition accuracy may be the precision rate and the recall rate as described above. In addition, either the precision rate or the recall rate may be calculated as the recognition accuracy. Alternatively, the recognition accuracy other than the precision rate and the recall rate may be calculated.

According to the above configuration, the weight of the additional word can be calculated appropriately and reliably. However, it is not always necessary to calculate the recognition accuracy and determine the increase or decrease in the weight based on the recognition accuracy. The weight of the additional word may be calculated by using equation (i) and equation (iii) or one of these without determining the increase or decrease in the weight.

In addition, the block diagrams used in the description of the above embodiment show blocks in functional units. These functional blocks (configuration units) are implemented by any combination of at least one of hardware and software. In addition, a method of implementing each functional block is not particularly limited. That is, each functional block may be implemented using one physically or logically coupled device, or may be implemented by connecting two or more physically or logically separated devices directly or indirectly (for example, using a wired or wireless connection) and using the plurality of devices. Each functional block may be implemented by combining the above-described one device or the above-described plurality of devices with software.

Functions include determining, judging, calculating, computing, processing, deriving, investigating, searching, ascertaining, receiving, transmitting, outputting, accessing, resolving, selecting, choosing, establishing, comparing, assuming, expecting, regarding, broadcasting, notifying, communicating, forwarding, configuring, reconfiguring, allocating, mapping, assigning, and the like, but are not limited thereto. For example, a functional block (configuration unit) that makes the transmission work is called a transmitting unit or a transmitter. In any case, as described above, the implementation method is not particularly limited.

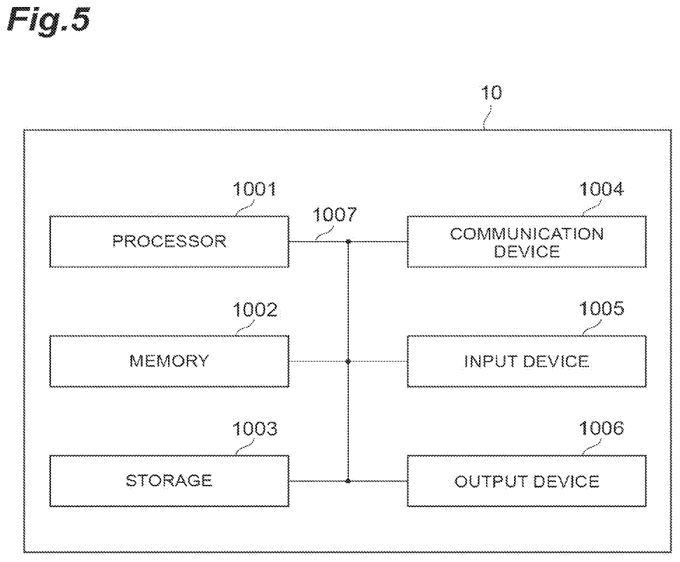

For example, the word weight calculation system 10 according to an embodiment of the present disclosure may function as a computer that performs information processing of the present disclosure. FIG. 5 is a diagram showing an example of a hardware configuration of the word weight calculation system 10 according to an embodiment of the present disclosure. The word weight calculation system 10 described above may be physically configured as a computer device including a processor 1001, a memory 1002, a storage 1003, a communication device 1004, an input device 1005, an output device 1006, a bus 1007, and the like.

In addition, in the following description, the term “device” can be read as a circuit, a device, a unit, and the like. The hardware configuration of the word weight calculation system 10 may be configured to include one or more devices for each of the devices shown in the diagram, or may be configured not to include some devices.

Each function in the word weight calculation system 10 is implemented by reading predetermined software (program) onto hardware, such as the processor 1001 and the memory 1002, so that the processor 1001 performs an operation and controlling communication by the communication device 1004, or by controlling at least one of reading and writing of data in the memory 1002 and the storage 1003.

The processor 1001 controls the entire computer by operating an operating system, for example. The processor 1001 may be configured by a central processing unit (CPU) including an interface with peripheral equipment, a control device, an operation device, a register, and the like.

For example, each function in the word weight calculation system 10 described above may be implemented by the processor 1001.

In addition, the processor 1001 reads a program (program code), a software module, data, and the like into the memory 1002 from at least one of the storage 1003 and the communication device 1004, and executes various kinds of processing according to these. As the program, a program causing a computer to execute at least a part of the operation described in the above embodiment is used. For example, each function in the word weight calculation system 10 may be implemented by a control program that is stored in the memory 1002 and operates in the processor 1001. Although it has been described that the various kinds of processing described above are executed by one processor 1001, the various kinds of processing described above may be executed simultaneously or sequentially by two or more processors 1001. The processor 1001 may be implemented by one or more chips. In addition, the program may be transmitted from a network through a telecommunication line.

The memory 1002 is a computer-readable recording medium, and may be configured by at least one of, for example, a ROM (Read Only Memory), an EPROM (Erasable Programmable ROM), an EEPROM (Electrically Erasable Programmable ROM), and a RAM (Random Access Memory). The memory 1002 may be called a register, a cache, a main memory (main storage device), and the like. The memory 1002 can store a program (program code), a software module, and the like that can be executed to perform the information processing according to an embodiment of the present disclosure.

The storage 1003 is a computer-readable recording medium, and may be configured by at least one of, for example, an optical disk such as a CD-ROM (Compact Disc ROM), a hard disk drive, a flexible disk, and a magneto-optical disk (for example, a compact disk, a digital versatile disk, and a Blu-ray (Registered trademark) disk), a smart card, a flash memory (for example, a card, a stick, a key drive), a floppy (registered trademark) disk, and a magnetic strip. The storage 1003 may be called an auxiliary storage device. The storage medium provided in the word weight calculation system 10 may be, for example, a database including at least one of the memory 1002 and the storage 1003, a server, or other appropriate media.

The communication device 1004 is hardware (transmitting and receiving device) for performing communication between computers through at least one of a wired network and a radio network, and is also referred to as, for example, a network device, a network controller, a network card, and a communication module.

The input device 1005 is an input device (for example, a keyboard, a mouse, a microphone, a switch, a button, and a sensor) for receiving an input from the outside. The output device 1006 is an output device (for example, a display, a speaker, and an LED lamp) that performs output to the outside. In addition, the input device 1005 and the output device 1006 may be integrated (for example, a touch panel).

In addition, respective devices, such as the processor 1001 and the memory 1002, are connected to each other by the bus 1007 for communicating information. The bus 1007 may be configured using a single bus, or may be configured using a different bus for each device.

In addition, the word weight calculation system 10 may be configured to include hardware, such as a microprocessor, a digital signal processor (DSP), an ASIC (Application Specific Integrated Circuit), a PLD (Programmable Logic Device), and an FPGA (Field Programmable Gate Array), and some or all of the functional blocks may be implemented by the hardware. For example, the processor 1001 may be implemented using at least one of these hardware components.

In the processing procedure, sequence, flowchart, and the like in each aspect/embodiment described in this disclosure, the order may be changed as long as there is no contradiction. For example, for the methods described in the present disclosure, elements of various steps are presented using an exemplary order, and the invention is not limited to the specific order presented.

Information or the like that is input and output may be stored in a specific place (for example, a memory) or may be managed using a management table. The information or the like that is input and output can be overwritten, updated, or added. The information or the like that is output may be deleted. The information or the like that is input may be transmitted to another device.

The judging may be performed based on a value (0 or 1) expressed by 1 bit, may be performed based on the Boolean value

(Boolean: true or false), or may be performed by numerical value comparison (for example, comparison with a predetermined value).

Each aspect/embodiment described in the present disclosure may be used alone, may be used in combination, or may be switched and used according to execution. In addition, the notification of predetermined information (for example, notification of “X”) is not limited to being explicitly performed, and may be performed implicitly (for example, without the notification of the predetermined information).

While the present disclosure has been described in detail, it is apparent to those skilled in the art that the present disclosure is not limited to the embodiments described in the present disclosure. The present disclosure can be implemented as modified and changed aspects without departing from the spirit and scope of the present disclosure defined by the description of the claims. Therefore, the description of the present disclosure is intended for illustrative purposes, and has no restrictive meaning to the present disclosure.

Software, regardless of whether this is called software, firmware, middleware, microcode, a hardware description language, or any other name, should be interpreted broadly to mean instructions, instruction sets, codes, code segments, program codes, programs, subprograms, software modules, applications, software applications, software packages, routines, subroutines, objects, executable files, execution threads, procedures, functions, and the like.

In addition, software, instructions, information, and the like may be transmitted and received through a transmission medium. For example, in a case where software is transmitted from a website, a server, or other remote sources using at least one of the wired technology (coaxial cable, optical fiber cable, twisted pair, digital subscriber line (DSL), and the like) and the wireless technology (infrared, microwave, and the like), at least one of the wired technology and the wireless technology is included within the definition of the transmission medium.

The terms “system” and “network” used in the present disclosure are used interchangeably.

In addition, the information, parameters, and the like described in the present disclosure may be expressed using an absolute value, may be expressed using a relative value from a predetermined value, or may be expressed using another corresponding information.

The terms “determining” used in the present disclosure may involve a wide variety of operations. For example, “determining” can include considering judging, calculating, computing, processing, deriving, investigating, looking up (search, inquiry) (for example, looking up in a table, database, or another data structure), and ascertaining as “determining”. In addition, “determining” can include considering receiving (for example, receiving information), transmitting (for example, transmitting information), input, output, accessing (for example, accessing data in a memory) as “determining”. In addition, “determining” can include considering resolving, selecting, choosing, establishing, comparing, and the like as “determining”. In other words, “determining” can include considering any operation as “determining”. In addition, “determining” may be read as “assuming”, “expecting”, “considering”, and the like.

The terms “connected” and “coupled” or variations thereof mean any direct or indirect connection or coupling between two or more elements, and can include a case where one or more intermediate elements are present between two elements “connected” or “coupled” to each other. The coupling or connection between elements may be physical, logical, or a combination thereof. For example, “connection” may be read as “access”. When used in the present disclosure, two elements can be considered to be “connected” or “coupled” to each other using at least one of one or more wires, cables, and printed electrical connections and using some non-limiting and non-inclusive examples, such as electromagnetic energy having wavelengths in a radio frequency domain, a microwave domain, and a light (both visible and invisible) domain.

The description “based on” used in the present disclosure does not mean “based only on” unless otherwise specified. In other words, the description “based on” means both “based only on” and “based at least on”.

Any reference to elements using designations such as “first” and “second” used in the present disclosure does not generally limit the quantity or order of the elements. These designations can be used in the present disclosure as a convenient method for distinguishing between two or more elements. Therefore, references to first and second elements do not mean that only two elements can be adopted or that the first element should precede the second element in any way.

When “include”, “including”, and variations thereof are used in the present disclosure, these terms are intended to be inclusive similarly to the term “comprising”. In addition, the term “or” used in the present disclosure is intended not to be an exclusive-OR.

In the present disclosure, in a case where articles, for example, a, an, and the in English, are added by translation, the present disclosure may include that nouns subsequent to these articles are plural.

In the present disclosure, the expression “A and B are different” may mean “A and B are different from each other”. In addition, the expression may mean that “A and B each are different from C”. Terms such as “separate”, “coupled” may be interpreted similarly to “different”.

### REFERENCE SIGNS LIST

10: word weight calculation system, 11: text acquisition unit, 12:

recognition accuracy calculation unit, 13: weight increase and decrease determination unit, 14: weight calculation unit, 1001: processor, 1002: memory, 1003: storage, 1004: communication device, 1005: input device, 1006: output device, 1007: bus.

1. A word weight calculation system for calculating a weight of an additional word registered in a word dictionary used for speech recognition, comprising circuitry configured to:
acquire a combination of a speech recognition result text, which is a result of speech recognition using a word dictionary including an additional word with a predetermined weight set in advance, and a correct text, which is a correct answer for the speech recognition, the combination including the additional word in any of the texts; and
calculate the weight of the additional word according to an erroneous word corresponding to the additional word included in any of the acquired texts, and a preset number of preceding words before the additional word or the erroneous word included in the correct text.

2. The word weight calculation system according to claim 1,
wherein the circuitry calculates a probability that the erroneous word appears after the preceding words based on a speech recognition model used for the speech recognition and calculates the weight of the additional word according to the calculated probability.

3. The word weight calculation system according to claim 2,
wherein a word registered in the word dictionary belongs to any of a plurality of classes set in advance, and
the circuitry calculates a probability that a word of a class, to which the additional word belongs, appears after the preceding words based on the speech recognition model used for the speech recognition and calculates the weight of the additional word also according to the calculated probability.

4. The word weight calculation system according to claim 1,
wherein the circuitry calculates a recognition accuracy of the additional word from the combination of the speech recognition result text and the correct text,
determines an increase or decrease from the predetermined weight based on the calculated recognition accuracy, and
calculates the weight of the additional word also according to the determination.

5. The word weight calculation system according to claim 4,
wherein the circuitry calculates at least one of a precision rate and a recall rate as the recognition accuracy of the additional word.

6. The word weight calculation system according to claim 2,
wherein the circuitry calculates a recognition accuracy of the additional word from the combination of the speech recognition result text and the correct text,
determines an increase or decrease from the predetermined weight based on the calculated recognition accuracy, and
calculates the weight of the additional word also according to the determination.

7. The word weight calculation system according to claim 3,
wherein the circuitry calculates a recognition accuracy of the additional word from the combination of the speech recognition result text and the correct text,
determines an increase or decrease from the predetermined weight based on the calculated recognition accuracy, and
calculates the weight of the additional word also according to the determination.
